(19) United States
(12) Patent Application Publication
(10) Pub. No.: US 2007/0206697 A1
(43) Pub. Date: Sep. 6, 2007

(54) SIGNAL RECEIVING METHOD AND SIGNAL RECEIVING EQUIPMENT FOR MULTIPLE INPUT MULTIPLE OUTPUT WIRELESS COMMUNICATION SYSTEM

(75) Inventors: Wei Qiu, Beijing (CN); Xinglin Wang, Beijing (CN); Jie Zhang, Beijing (CN)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 11/682,690

(22) Filed: Mar. 6, 2007

(30) Foreign Application Priority Data
Mar. 6, 2006 (CN) 200610056710.1
Jul. 5, 2006 (GB) 0613269.0

(51) Int. Cl. H04L 1/02

(52) U.S. Cl. 375/267

(57) ABSTRACT

In a multiple input/multiple output wireless communication system, a receiving signal is compensated based on a wireless channel state information matrix converted by lattice reduction. The distortion of the modulation constellation diagram of a signal is considered, a detection signal is processed, and an intermediate signal table containing at least two intermediate signals is obtained to increase the area for the detection signal to be decided correctly, thereby to improve the possibility of the correct detection of the signal. Then a candidate signal table is obtained from the intermediate signal table and, based on the candidate signal table, a decision signal for a transmitting signal is obtained, thereby improving the accuracy of the detection of the transmitting signal. When at a high signal-to-noise ratio, the bit-error performance approaches the bit-error performance of a system using maximum likelihood detection algorithm, while causing no significant increase in computation complexity.

### CROSS REFERENCE TO RELATED APPLICATIONS

This application is based on and hereby claims priority to Chinese Application No. 200610056710.1 filed on Mar. 6, 2006 and Great Britain Application No. 0613269.0 filed on Jul. 5, 2006, the contents of which are hereby incorporated by reference.

### BACKGROUND

This invention relates to a wireless communication method and wireless communication equipment, and more particularly, to a signal receiving method and signal receiving equipment for multiple input/multiple output wireless communication systems.

Wireless communication resources have always been an extremely important determining element in the development of wireless transmission technologies, and how to make efficient use of limited wireless communication resources has always been one of the key research points for communication workers. In recent years, multiple input/multiple output (MIMO) wireless transmission technology has received more and more attention due to its highly efficient use of wireless communication resources.

In MIMO wireless transmission technology, as shown in FIG. 1, the wireless signal's transmitting end TX and receiving end RX are respectively equipped with a plurality of antenna units; and by way of the spatial separation of the plural antenna units, the wireless transmission's spatial resources are utilized to achieve spatial diversity gain or to improve wireless signal's transmission speed.

In MIMO wireless transmission technology, spatial diversity transmission and spatial multiplex transmission are the two major transmission schemes. In the spatial diversity transmission scheme, for example using the space time block coded (STBC) transmission scheme, the data flow of space-time coded multi-channel wireless signals is transmitted simultaneously via the plural antenna units, so as to achieve the spatial diversity gain and to improve the wireless signal's transmission performance. In the spatial multiplex transmission scheme, such as the Vertical Bell Laboratories Layered Space Time (BLAST) transmission scheme proposed by Bell Laboratories, the data flow of the multi-channel wireless signal is transmitted simultaneously via the plural antenna units by a spatial multiplex scheme to increase significantly the wireless signal's transmission speed.

Theoretically speaking, in MIMO wireless transmission technology, the achievable gain for wireless signals' transmission speed or transmission performance would have an increase close to linear with the increase in the number of the antenna units. Therefore, MIMO wireless transmission technology has been considered as one of the development trends for the physical structure of future high speed wireless communication systems.

In the BLAST transmission scheme proposed by Bell Laboratories, when the wireless signal's receiving end detects the transmitting signal, the algorithms that can usually be used include: zero forcing (ZF) detection, minimum mean square error (MMSE) detection, interference cancellation detection and maximum likelihood (ML) detection, etc. Among these usual detection algorithms, there is a conflict between increasing the detection performance and reducing the computation complexity. The better a detection algorithm's detection performance, the more complex its computation will be, while the detection algorithm of relatively low computation complexity would have less good detection performance. For example, the maximum likelihood detection algorithm and the interference cancellation detection algorithm are non-linear detection algorithms, which have high computation complexity and quite good detection performance. Of these the maximum likelihood detection algorithm is the better detection algorithm, but its computation complexity increases exponentially with the increase in the number of antenna units. When the number of antenna units is relatively large, the maximum likelihood detection algorithm's computation complexity would be too high to accomplish. Both the zero forcing detection algorithm and the minimum mean square error detection algorithm are linear detection algorithms with relatively low computation complexity but less good detection performance. Particularly when the state of the wireless channels between the transmitting antenna units and the receiving antenna units is relatively bad, the linear detection algorithms' detection performance would deteriorate significantly.

In order to solve the conflict between the detection performance and computation complexity during the MIMO signal receiving process, a lattice-reduction-aided detection algorithm was proposed by Huan Yao and G. W. Wornell et al., also called lattice reduction detection algorithm, which can reduce the detection algorithm's computation complexity with the advantage of not significantly reducing detection performance. In this detection algorithm, the lattice reduction conversion in algebra is used in conjunction with the above linear detection algorithms or the interference cancellation detection algorithm, so the transmission signal's detection performance can be improved significantly and at the same time it can also keep the computation complexity virtually unchanged.

In algebra, lattice in an n-dimensional real number space is defined as ψ={s|s=Bλ}. Wherein, B=[b₁ b₂ . . . bₙ], the column vectors b₁ to bₙ of B form a group of base vectors of the lattice ψ, and B is called a basis of the lattice ψ. λ=[λ₁ λ₂ . . . λₙ]^{T}, which is an integer weighted column vector, namely each λᵢ is an integer, i=1, 2, . . . , n. As to a lattice ψ, if B is a basis of it, after using a matrix T to perform a linear conversion to B, wherein the matrix T contains only integer elements and det(T)=±1, the matrix obtained [symbol] =BT would also be a basis of the lattice ψ. In the ψ, when B is a basis, x represents a point s=Bx, and when z,900 is a basis, it will be converted so that z=T⁻¹x represents a point, namely s=Bx=(BT)(T⁻¹x)= [symbol] z. Lattice reduction conversion refers to a linear conversion performed to a basis B of lattice ψ, so that in [symbol] obtained after the conversion the base vectors are shorter, and the correlation between the base vectors in [symbol] is lower.

Signals received by a MIMO signal receiver are represented as y_{c}=H_{c}x_{c}+n_{c}, wherein H_{c} represents a wireless channel state information matrix of n_{R} rows and n_{T} columns between the transmitting antenna units and the receiving antenna units; n_{R} is the number of receiving antenna units, n_{T} is the number of transmitting antenna units, and an element in the matrix represents the amplitude characters and phase characters of a wireless channel between a transmitting antenna unit and a receiving antenna unit; x_{c} represents the transmitting signal's column vector of n_{T} rows, y_{c} represents the receiving signal's column vector of n_{R} rows, and n_{c} represents the complex additive white Gaussian noise signals' column vector of n_{R} rows. When the lattice reduction conversion is used in conjunction with the linear detection algorithms or the interference cancellation detection algorithm, the above mentioned receiving signal's expression format of complex numbers can be converted into an expression format of real numbers, namely to express it as y=Hx+n, wherein

$$H = [ \begin{matrix}ℜ ( {H}_{c} ) & - 𝔍 ( {H}_{c} ) \\ 𝔍 ( {H}_{c} ) & ℜ ( {H}_{c} )\end{matrix} ] , \\ x = [ \begin{matrix}ℜ ( {x}_{c} ) \\ 𝔍 ( {x}_{c} )\end{matrix} ] , \\ y = [ \begin{matrix}ℜ ( {y}_{c} ) \\ 𝔍 ( {y}_{c} )\end{matrix} ] , \\ n = [ \begin{matrix}ℜ ( {n}_{c} ) \\ 𝔍 ( {n}_{c} )\end{matrix} ] .$$

Following this, the lattice reduction conversion is first performed on the wireless channel state information matrix H, and after the conversion the wireless channel state information matrix is [symbol] =HT. By selecting a suitable matrix T, after the conversion the column vectors in the wireless channel state information matrix [symbol] have the character of quasi-orthogonal between them. Under the wireless channel state information matrix [symbol] after the conversion, the receiving signals would be expressed as y=(HT)(T⁻¹x)+n=\tilde{H}z+n. Then, based on [symbol] , compensation is made to y by using linear detection algorithms or interference cancellation detection algorithm to obtain a detection signal \tilde{z}. The detection signal \tilde{z} is sliced or quantized to obtain quantized signal \hat{z}. Finally, the quantized signal \hat{z} is multiplied by the conversion matrix T, and then to obtain the detection signal \hat{x}=T\hat{z} of the transmitted signal x. For example, when the zero forcing detection algorithm is used, the inverse matrix or pseudo-inverse matrix [symbol] ^{†} of [symbol] is right-multiplied by y, to obtain the detection signal \tilde{z}, by quantizing the detection signal \tilde{z} to obtain the quantized signal \hat{z}, and then to obtain the detection signal \hat{x}=T\hat{z}.

Since in the lattice reduction detection algorithm, the characteristics of wireless channel state information matrix are improved by the lattice reduction conversion, namely after the conversion the column vectors in the wireless channel state information matrix †, when compared with the column vectors in the unconverted wireless channel state information matrix H, have lower correlation between themselves or have the quasi-orthogonal characteristics, and the lengths of the vectors are shorter, therefore the detection performance by the linear detection algorithm or the interference cancellation detection algorithm gets improved.

However, there exist in the lattice reduction detection algorithm the following problems: assuming in a MIMO wireless communication system the transmitting signals x adopt 16QAM (Quadrature Amplitude Modulation) scheme for modulation,

$$x ∈ {S}^{2} , S = \{ \pm 1 , \pm 3 \} ,$$

the modulation constellation diagram is as shown in FIG. 2. After performing lattice reduction conversion to the wireless channel state information matrix H between the transmitting antenna units and the receiving antenna units, the original transmitting signal x would be converted into signals z=T⁻x under the new wireless channel state information matrix [symbol] . Further assuming T⁻¹ is

$$[ \begin{matrix}2 & - 1 \\ - 1 & 1\end{matrix} ] ,$$

then it is not difficult to see the modulation constellation diagram of the signals z would be distorted as that shown in FIG. 3. Corresponding to the change of the modulation constellation diagram, the decision domain of the detection signal \tilde{z} would also change from the rectangular area shown in FIG. 2 into a parallelogram area as shown in FIG. 3.

However, when detecting signals z, for example by using zero forcing detection algorithm, firstly the pseudo-inverse matrix [symbol] ^{†} of [symbol] is right-multiplied by y, to obtain the detection signal \tilde{z}. Then, when \tilde{z} is quantized, if linear quantization are simply performed on the two elements in \tilde{z} respectively, the actual decision domain of \tilde{z} would be made into a rectangular area, instead of a parallelogram area as shown in FIG. 3, which would lead to the wrong detection of the signal z, and then lead to the wrong detection of the transmitting signal x.

In order to avoid this kind of wrong detection mentioned above, in consideration of x∈S², while z=T⁻¹x∈T⁻¹S², it is necessary to perform non-linear quantization in T⁻¹S² space when the detection signal \tilde{z} is quantized. However, since the elements in the converted signal z are not always mutually independent, and to a different matrix H_{c}, the matrix T used for lattice reduction conversion is not always the same, it is therefore difficult to perform non-linear quantization to \tilde{z} in T⁻¹S² space. Furthermore, when the number of antenna units is large, the computation volume for the abovementioned non-linear quantization would be huge, and would therefore also restrict the exploitation of the non-linear quantization.

For detailed description regarding the lattice reduction detection method, please refer to the thesis by the authors of Huan Yao and G. W. Wornell, “Lattice-reduction-aided detectors for MIMO communication systems” GLOBECOM '02. IEEE, Volume: 1, 17-21 Nov. 2002, Pages: 424-428.

Aiming at the signal detection problems in multiple input/multiple output wireless communication systems, the object of this invention is to propose a method for receiving signals in a multiple input/multiple output wireless communication system, which can significantly improve the signal detection performance of a multiple input/multiple output wireless communication system based on the current algorithms of linear detection, interference cancellation detection or lattice reduction detection, etc., and when at a high signal-to-noise ratio, the bit-error performance when using the signal receiving method of this invention is close to the bit-error performance of a system using maximum likelihood detection algorithm. At the same time, the signal receiving method proposed in this invention would not lead to any significant increase in the system's computation complexity, therefore the exploitation of the method of this invention has relatively good feasibility.

### SUMMARY

It is also an object of this invention to propose signal receiving equipment for a multiple input/multiple output wireless communication system, for applying the signal receiving method of this invention.

Accordingly, a method for receiving signals in a multiple input/multiple output wireless communication system, includes the following steps:

(1) obtaining a wireless channel state information matrix H;

(2) applying lattice reduction conversion to the matrix H to obtain a converted wireless channel state information matrix \tilde{H}=HT

(3) compensating a receiving signal y based on the matrix \tilde{H}, to obtain a detection signal \tilde{z};

(4) obtaining an intermediate signal table L_{D} based on the detection signal \tilde{z}, with the table L_{D} consisting of at least two intermediate signals \hat{z}_{D};

(5) multiplying respectively the intermediate signals \hat{z}_{D} by the converting matrix T;

(6) obtaining a candidate signal table L by confining each product signal T\hat{z}_{D} into the signal in a modulation constellation diagram for a transmitting signal x, with the table L consisting of at least one candidate signal \hat{x}_{D};

(7) obtaining a decision signal bit \hat{b} based on the candidate signal table L.

In the present invention, the channel matrix H is pre-processed by a uni-modular matrix T through a lattice reduction algorithm, so that a table L_{D} of as little as two vectors can achieve very high performance with reduced complexity, the candidate transmit vectors being selected based on a converted transmit constellation z.

Preferably, in the step (3) a linear detection algorithm or a serial interference cancellation detection algorithm is used in compensating the receiving signal y.

Preferably, step (4) includes:

(4a) quantizing respectively each element in the detection signal \tilde{z} into a closest integer;

(4b) selecting from the detection signal \tilde{z} at least one most unreliable element, and quantizing respectively the selected element once again into a next closest integer;

(4c) combining the integers obtained by quantizing the elements, so as to obtain the intermediate signal table L_{D}.

Preferably, the most unreliable element is the element whose difference with its closest integer has the largest absolute value.

Preferably, step (7) includes:

(7a) multiplying respectively the candidate signals \hat{x}_{D} in the candidate signal table L with the wireless channel state information matrix H;

(7b) selecting from the candidate signals \hat{x}_{D} the candidate signal i which produces the smallest Euclidean distance between the product signal H\hat{x}_{D} and the receiving signal y;

(7c) demodulating the selected signal \hat{x} to obtain the decision signal bit \hat{b}.

Alternatively, in step (7) a detecting and decoding iteration method is used based on the candidate signal table L to obtain the decision signal bit \hat{b}. Then preferably, step (7) includes:

(7a) obtaining first extrinsic Information I_{E1} of a transmitting signal bit b based on the candidate signal table L and first prior Information I_{A1} of the transmitting signal bit b, and de-interleaving the first extrinsic Information I_{E1} to obtain second prior Information I_{A2} of the transmitting signal bit b;

(7b) applying channel decoding to the second prior Information I_{A2}, so as to obtain second extrinsic Information I_{E2} of the transmitting signal bit b, and interleaving the second extrinsic Information I_{E2} to obtain the first prior Information I_{A1};

(7c) obtaining the decision signal bit \hat{b} based on the second prior Information I_{A2}.

Preferably, the multiple input/multiple output wireless communication system is a multiple input/multiple output multiple carrier wireless communication system. When receiving signals of the multiple input multiple/output multiple carrier wireless communication system before step (1), it also includes separating receiving signals y_{ƒ} on the sub-carriers of the multiple carrier system.

Preferably, the signal receiving equipment in a multiple input/multiple output wireless communication system includes:

a wireless channel state information acquisition unit for acquiring a wireless channel state information matrix H;

a lattice reduction conversion unit for applying lattice reduction conversion to the matrix H, so as to obtain a converted wireless channel state information matrix \tilde{H}=HT;

a compensation unit for compensating a receiving signal y based on the matrix \tilde{H} to obtain a detection signal \tilde{z};

a first signal processing unit for obtaining a candidate signal table L based on the detection signal \tilde{z}, with the table L consisting of at least one candidate signal \hat{x}_{D};

a second signal processing unit for multiplying respectively the intermediate signals \hat{z}_{D} by the converting matrix T, and for obtaining a candidate signal table L by confining each product signal T\hat{z}_{D} into the signal in a modulation constellation diagram for a transmitting signal x, with the table L consisting of at least one candidate signal \hat{x}_{D}; and

a decision unit for obtaining a decision signal bit \hat{b} based on the candidate signal table L.

Preferably, the compensation unit uses a linear detection algorithm, or a serial interference cancellation detection algorithm to compensate the receiving signal y.

Preferably, the first signal processing unit first quantizes respectively each element in the detection signal \tilde{z} into a closest integer; then selects from the detection signal \tilde{z} at least one most unreliable element, and quantizes respectively the selected element once again into a next closest integer; and finally combines the integers obtained by quantizing the elements, so as to obtain the intermediate signal table L_{D}. Preferably, the most unreliable element is the element whose difference with its closest integer has the largest absolute value.

Preferably, the decision unit first multiplies respectively the candidate signals \hat{x}_{D} in the candidate signal table L with the wireless channel state information matrix H; then selects from the candidate signals \hat{x}_{D} the candidate signal \hat{x} which produces the smallest Euclidean distance between the product signal H\hat{x}_{D} and the receiving signal y; and finally the decision unit demodulates the selected signal \hat{x} to obtain the decision signal bit \hat{b}.

In one example, the decision unit uses a detecting and decoding iteration method to obtain the decision signal bit \hat{b} based on the candidate signal table L. Then the decision unit first obtains first extrinsic Information I_{E1} of a transmitting signal bit based on the candidate signal table L and first prior Information I_{A1} of the transmitting signal bit, and de-interleaves the first extrinsic Information I_{E1} to obtain second prior Information I_{A2} of the transmitting signal bit; then performs channel decoding to the second prior Information I_{A2}, so as to obtain second extrinsic Information I_{E2} of the transmitting signal bit, and interleaves the second extrinsic Information I_{E2} to obtain the first prior Information I_{A1}; and finally obtains the decision signal bit \hat{b} based on the second prior Information I_{A2}.

Preferably, the signal receiving equipment in the multiple input/multiple output multiple carrier wireless communication system further includes a filter unit for separating receiving signals y_{ƒ} on the sub-carriers of the multiple carrier system.

### BRIEF DESCRIPTION OF THE DRAWINGS

These and other objects and advantages will become more apparent and more readily appreciated from the following description of exemplary practical embodiments, without any restrictive effect, taken in conjunction with the accompanying drawings of which:

FIG. 1 is a block diagram of a multiple input/multiple output wireless communication system;

FIG. 2 is a modulation constellation diagram and a decision domain of transmitting signal x;

FIG. 3 is the modulation constellation diagram and decision domain of signal Z after conversion;

FIG. 4 is a flow chart of a practical embodiment according to the method of this invention;

FIG. 5 is the modulation constellation diagram and decision domain of signal z in a practical embodiment according to the method of this invention;

FIG. 6 is another modulation constellation diagram and decision domain of signal z in a practical embodiment according to the method of this invention;

FIG. 7 is a graph of the bit-error rate performance curves of the current linear detection algorithms and the linear detection algorithms according to the method of this invention;

FIG. 8 is a graph of the bit-error rate performance curves of the current serial interference cancellation detection algorithm and the serial interference cancellation detection algorithm according to the method of this invention;

FIG. 9 is a graph of the relationship curves of the number of intermediate signals \hat{z}_{D} and the bit-error rate according to the method of this invention;

FIG. 10 is a graph of the relationship curve of the number of intermediate signals \hat{z}_{D} and the number of candidate signals \hat{x}_{D} according to the method of this invention; and

FIG. 11 is a block diagram of a multiple input/multiple output wireless communication system having components performing the method described below.

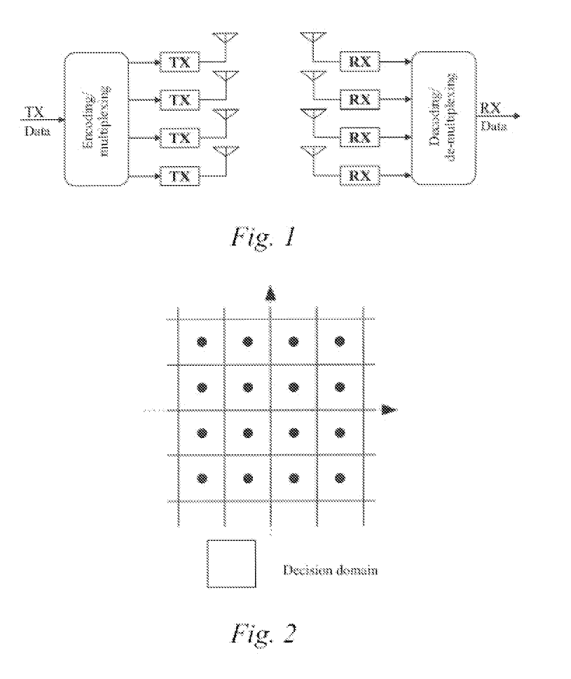

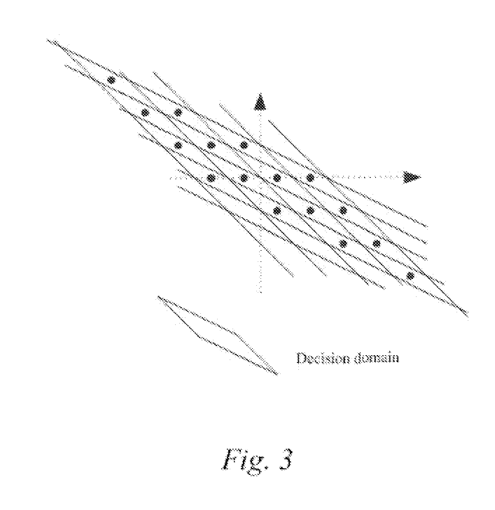

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

The key point of this invention is: after having applied linear conversion to the wireless channel state information matrix H by using lattice reduction conversion, and when a current detection algorithm is used to compensate the receiving signal y based on converted wireless channel state information matrix \tilde{H}, as to the obtained detection signal \tilde{z}, in consideration of the distortion of the modulation constellation diagram of signal z, further processing is made to the detection signal \tilde{z} to obtain an intermediate signal table L_{D} consisting of at least two intermediate signals \hat{z}_{D}, so as to increase the area for the detection signal \tilde{z} to get the correct decision, thereby increasing the correct detection probability for signal z. Then, a candidate signal table L is obtained from the intermediate signal table L_{D}, and to obtain the transmitting signal's decision signal based on the candidate signal table L, and thereby to finally increase the correct detection probability for the transmitting signals.

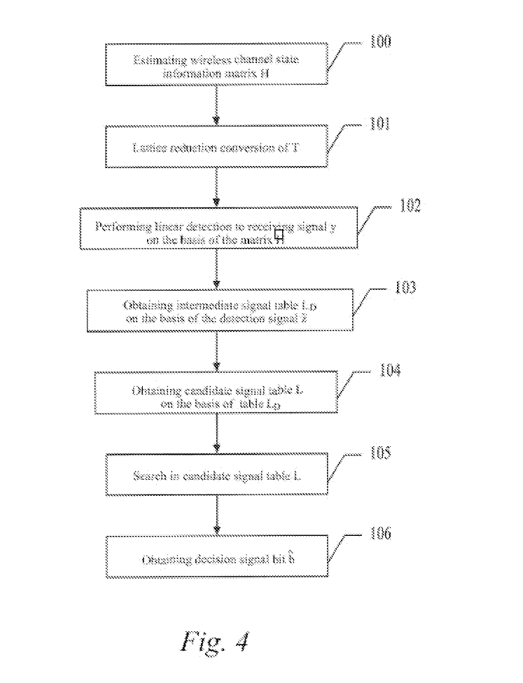

According to the signal receiving method of this invention, FIG. 4 shows the flow chart of a practical embodiment of the method of this invention. In a step 100, a pilot channel in the system or beacon signals such as a channel midamble sign can be used to obtain the wireless channel state information matrix H by using a known channel estimation method. In a step 101, lattice reduction conversion is performed on the matrix H to obtain a converted wireless channel state matrix [symbol] =HT. In a step 102, based on the matrix [symbol] , compensation is made to the receiving signal y by using a linear detection algorithm to obtain the detection signal \tilde{z}= [symbol] ^{†}y=z+ [symbol] ^{†}n. In a step 103, an intermediate signal table L_{D} is obtained based on the detection signal \tilde{z}, with the table L_{D} consisting of at least two intermediate signals \hat{z}_{D}. In a step 104, each the intermediate signal \hat{z}_{D} is multiplied with a conversion matrix T, and each product signal T\hat{z}_{D} is confined to the signal in the modulation constellation diagram of the transmitting signal x, so as to obtain a candidate signal table L, with the table L consisting of at least one candidate signal \hat{x}_{D}. In a step 105, each the candidate signal \hat{x}_{D} multiplies separately with the wireless channel state information matrix H, and a search is made in the candidate signal table L for the candidate signal \hat{x} which produces the smallest Euclidean distance between the product signal H\hat{x}_{D} and the receiving signal y. In a step 106, the selected signal \hat{x} is demodulated to obtain a hard decision signal bit \hat{b}.

In the practical embodiment, for example, in the step 102 the receiving signal y is compensated by using the zero forcing detection algorithm to obtain a detection signal \tilde{z}_{LR-ZF}= [symbol] ^{†}y=z+ [symbol] ^{†}n. In the step 103, in order to obtain an intermediate signal table L_{D} based on the detection signal \tilde{z}_{LR-ZF}, the elements in the signal \tilde{z}_{LR-ZF} can be quantized respectively into a closest integer value, and on this basis at least one most unreliable element is selected from the signal \tilde{z}_{LR-ZF}, and the selected elements are respectively quantized once again to a next closest integer. The most unreliable element refers to the element whose difference with its closest integer has the largest absolute value. Then, the integer values obtained by the quantization of the elements are combined. Each combined integer value sequence forms an intermediate signal \hat{z}_{D}, and all of the intermediate signals \hat{z}_{D} form the intermediate signal table L_{D}. It can be seen that when a most unreliable element is selected in the signal \tilde{z}_{LR-ZF}, the intermediate signal table L_{D} would be formed by two intermediate signals \hat{z}_{D}, and when two most unreliable elements are selected in the signal \tilde{z}_{LR-ZF}, the intermediate signal table L_{D} would be formed by four intermediate signals \hat{z}_{D}, and so on.

Hereinbelow still using the 16QAM modulation scheme as an example to illustrate the above processing to the detection signal \tilde{z}_{LR-ZF}, namely how to obtain an area for correct decision by increasing detection signal \tilde{z}_{LR-ZF}, thereby to improve the probability of correct detection of signal z. Still assuming

$${T}^{- 1} is [ \begin{matrix}2 & - 1 \\ - 1 & 1\end{matrix} ] , x ∈ {S}^{2} , S = \{ \pm 1 , \pm 3 \} ,$$

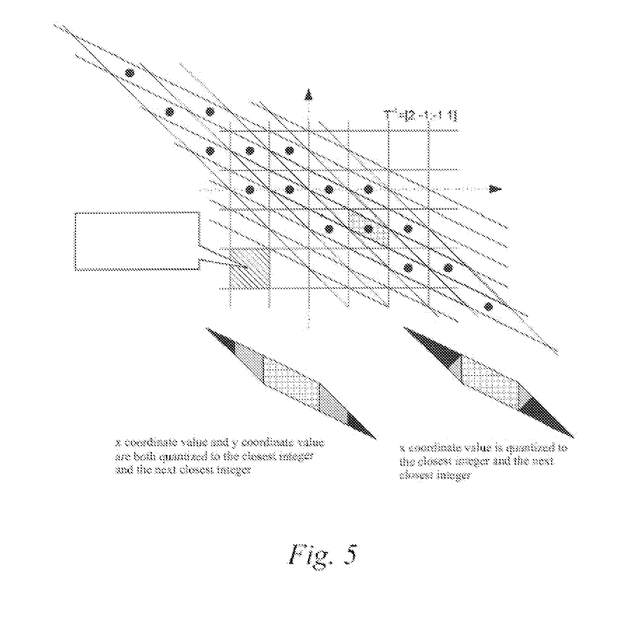

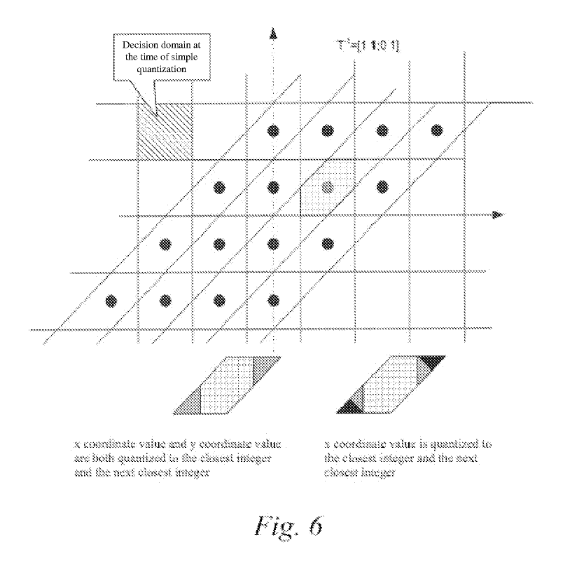

then the modulation constellation diagram of signal z=T⁻¹x is as shown in FIG. 5, and the decision domain for the detection signal \tilde{z}_{LR-ZF} should be the parallelogram shown in FIG. 5. When the elements in the detection signal \tilde{z}_{LR-ZF} are respectively quantized by using a simple quantization method, two of the elements in \tilde{z}_{LR-ZF} are respectively quantized into a closest integer value, and a corresponding actual decision domain is the rectangular area shown in FIG. 5. It can be seen that only when the detection signal \tilde{z}_{LR-ZF} falls into the overlapping area between the parallelogram area and the rectangular area, the detection signal \tilde{z}LR-ZF can get a correct decision. Here, according to the signal receiving method of this invention, the elements in the signal \tilde{z}_{LR-ZF} are respectively quantized into a closest integer value, and on this basis, at least one most unreliable element is selected from the signal \tilde{z}_{LR-ZF}, and the selected elements are respectively quantized once again to a next closest integer. As can be seen in FIG. 5, the elements in the detection signal \tilde{z}_{LR-ZF} correspond respectively to the x coordinate values or y coordinate values in the modulation constellation diagram of the signal z, therefore when the selected elements are quantized once again to a next closest integer value it is equivalent to having the x coordinate value or y coordinate value of the detection signal \tilde{z}_{LR-ZF} quantized into a closest integer value or a next closest integer value. Then it can be seen in FIG. 5 that when the detection signal \tilde{z}_{LR-ZF} falls into a grey area shown in the figure, the closest integer value or the next closest integer value obtained by the quantization can be correctly detected by the signal z, thereby the area for the detection signal \tilde{z}_{LR-ZF} to be correctly detected is increased. However, under the modulation constellation diagram of the signal Z as shown in FIG. 5, and even if the method of this invention is used and the above processing is made to the detection signal \tilde{z}_{LR-ZF}, when the detection signal \tilde{z}_{LR-ZF} falls into the black areas shown in the figure, it is still unable to be correctly detected by signal z. Nevertheless, in many occasions, the matrix T⁻¹ is often close to a sparse matrix, which means the correlation between the elements in the converted signal z would not be high; and in this case, according to the method of this invention, by having the x coordinate value or y coordinate value of the detection signal \tilde{z}_{LR-ZF} quantized into a closest integer value or a next closest integer value, it would enable the area for the correct decision by the detection signal \tilde{z}_{LR-ZF} to be increased into a decision domain under ideal conditions. For example, when

$${T}^{- 1} = [ \begin{matrix}1 & 1 \\ 0 & 1\end{matrix} ] ,$$

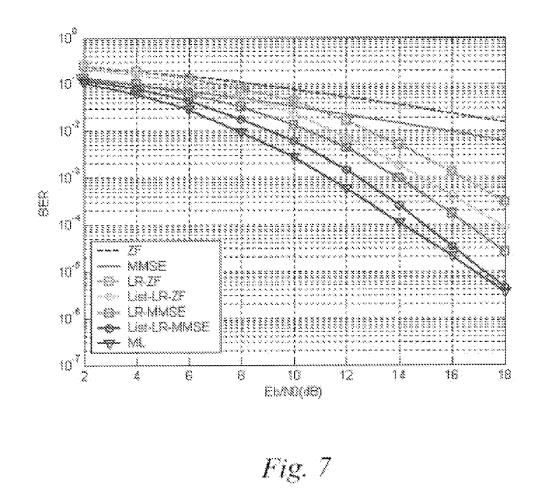

the modulation constellation diagram of signal z=T⁻¹x would be like that shown in FIG. 6. According to the method of this invention, based on having the x coordinate value or y coordinate value of the detection signal \tilde{z}_{LR-ZF} respectively quantized into a closest integer value, and then having the x coordinate value or y coordinate value of the detection signal \tilde{z}_{LR-ZF} respectively quantized once again into a next closest integer value, it would be able to make the area for the correct decision by the detection signal \tilde{z}_{LR-ZF} into a decision domain under ideal conditions.

Although the above description is made with 16QAM modulation scheme as an example, it is not difficult for those skilled in the art to understand that the signal receiving method according to this invention is equally suitable to MIMO wireless communication systems modulated by quadrature phase shift keying (QPSK), 32QAM, 64QAM or higher order QAM schemes.

In a second practical embodiment according to the signal receiving method of this invention, if the minimum mean square error detection algorithm is used to compensate the receiving signal y, then in a step 200 the obtained wireless channel state information matrix H and the receiving signal y are extended; the extended wireless channel state information matrix is

$$\underline{H} = [ \begin{matrix}H \\ σ {I}_{m}\end{matrix} ] ,$$

and the extended receiving signal is

$$\underline{y} = [ \begin{matrix}y \\ {0}_{m , 1}\end{matrix} ] ;$$

wherein σ represents the standard deviation of the complex additive white Gaussian noise signals, m=2n_{T}, Iₘ represents an identity matrix of m rows and m columns, 0_{m,1} represents a zero matrix of m rows and 1 column. In a step 201, lattice reduction conversion is applied to the matrix H to obtain a converted wireless channel state matrix =HT. Then in a step 202, as equivalent to the zero forcing detection algorithm, the pseudo-inverse matrix ^{†} of is right-multiplied by y, to obtain the detection signal \tilde{z}_{LR-MMSE}=^{†}y. Since the following steps are the same as those relevant steps above when using the zero forcing detection algorithm, redundant description will not be made here.

In a third practical embodiment according to the signal receiving method of this invention, after having obtained the lattice reduction converted wireless channel state information matrix [symbol] , QR decomposition is made to the matrix [symbol] , i.e. [symbol] = [symbol] [symbol] , then detection can be made to the signal z by using the serial interference cancellation detection algorithm, and the detection signal obtained is \tilde{z}_{LR-ZFSIC}= [symbol] ^{T}y= [symbol] z+ [symbol] ^{T}n. The following steps are the same as those relevant steps above when using the zero forcing detection algorithm.

In a fourth practical embodiment according to the signal receiving method of this invention, similarly, after having obtained the lattice reduction converted wireless channel state information matrix , QR decomposition is made to the matrix , i.e. [symbol] = [symbol] [symbol] , then detection can be made to the signal z by using the serial interference cancellation detection algorithm, and the detection signal obtained is \tilde{z}_{LR-MMSESIC}=^{T}y. The following steps are the same as those relevant steps above when using the zero forcing detection algorithm.

In a fifth practical embodiment according to the signal receiving method of this invention, when the decision signal bit \hat{b} is obtained based on the candidate signal table L, it can also use current iteration detection and decoding method to make computation of soft information of the transmitting signal bit based on the candidate signal table L, and to perform iteration with channel decoding process to obtain the decision signal bit \hat{b}, thereby to further improve the system's bit-error rate performance. The iteration detection and decoding method includes the following: making computation of a second prior information I_{A2} of the transmitting signal bit b based on the candidate signal table L and a first prior information I_{A1} of the transmitting signal bit b; performing channel decoding to the second prior information I_{A2} to obtain the first prior information I_{A1}; obtaining the decision signal bit \hat{b} based on the second prior information I_{A2}. At the same time, in order to increase the system's capability in resisting burst errors, the transmitting signal can be interleaved first, and then be channel-encoded; correspondingly, when obtaining the decision signal bit \hat{b} based on the candidate signal table L, it includes the following: obtaining first extrinsic Information I_{E1} of the transmitting signal bit b based on the candidate signal table L and the first prior Information I_{A1} of the transmitting signal bit b, and de-interleaving the first extrinsic Information I_{E1} to obtain the second prior Information I_{A2}, of the transmitting signal bit b; performing channel decoding to the second prior Information I_{A2}, so as to obtain second extrinsic Information I_{E2} of the transmitting signal bit b, and interleaving the second extrinsic Information I_{E2} to obtain the first prior Information I_{A1}; obtaining the decision signal bit \hat{b} based on the second prior Information I_{A2}. Regarding the detailed steps of iteration detection and channel decoding method, reference can be made to the thesis by Hochwald, B. M. and ten Brink, S. “Achieving near-capacity on a multiple-antenna channel” Communications, IEEE Transactions on, Volume: 51, Issue: 3, March 2003, Pages:389-399.

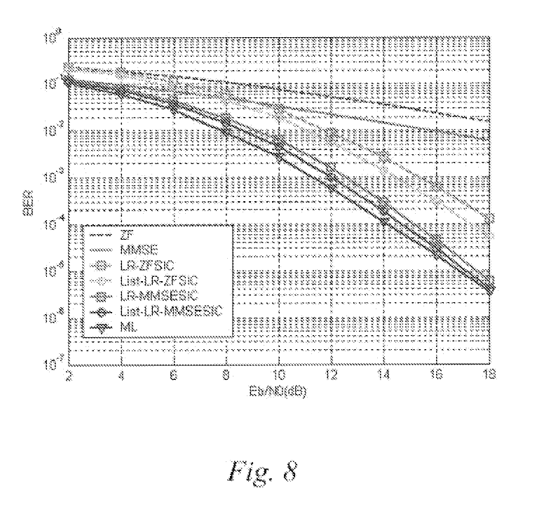

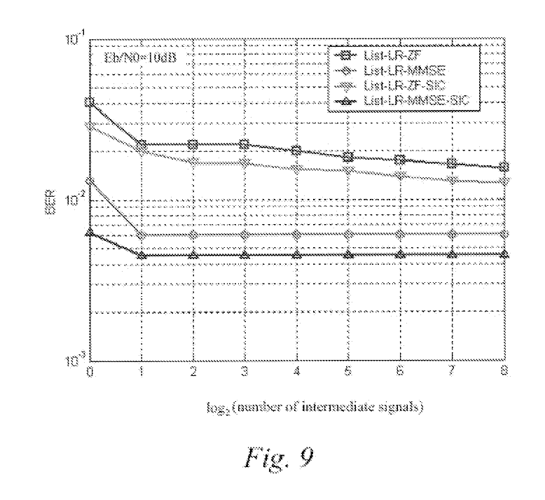

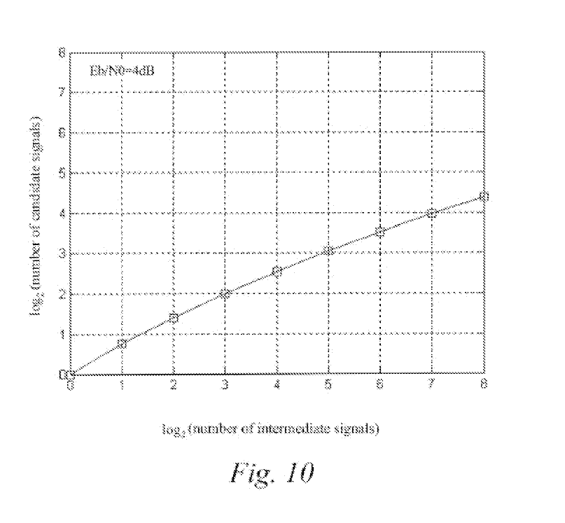

When both numbers of the transmitting antenna units and receiving antenna units are 4, simulation on signal receiving performance has been made to the current MIMO signal receiving methods and the signal receiving method according to this invention, and the simulation results are shown in FIGS. 7 and 8. In these, curves “ZF”, “MMSE” and “ML” represent respectively the bit-error rate performance by using the zero forcing detection algorithm, minimum mean square error detection algorithm and maximum likelihood detection algorithm; the curves “LR-ZF”, “LR-MMSE”, “LR-ZFSIC” and“LR-MMSESIC” represent the bit-error rate performance when the lattice reduction conversion is combined respectively with the zero forcing detection algorithm, the minimum mean square error detection algorithm, the zero forcing serial interference cancellation detection algorithm and the minimum mean square error serial interference cancellation detection algorithm; the curves “List-LR-ZF”, “List-LR-MMSE”, “List-LR-ZFSIC” and “List-LR-MMSESIC” represent respectively the bit-error rate performance of the zero forcing detection algorithm, the minimum mean square error detection algorithm, the zero forcing serial interference cancellation detection algorithm and the minimum mean square error serial interference cancellation detection algorithm using the method according to this invention. It can be seen from the bit-error rate performance curves that when the signal-to-noise ratio is high, the bit-error rate performance by using the minimum mean square error detection algorithm and the minimum mean square error serial interference cancellation detection algorithm according to the method of this invention approaches the bit-error rate performance by using the maximum likelihood detection algorithm. Furthermore, it can be seen from the relationship curves of the number of \hat{z}_{D} in the intermediate signal table L_{D} and the bit-error rate shown in FIG. 9 that the bit-error rate performance according to the signal receiving method of this invention does not decrease as the number of the intermediate signal \hat{z}_{D} is increased. When the number of the intermediate signal \hat{z}_{D} is 2, the bit-error rate performance according to the signal receiving method of this invention can achieve an expected and relatively good performance. Furthermore, it can be seen from the relationship curve of the number of intermediate signals \hat{z}_{D} in the intermediate signal table L_{D} and the number of candidate signals \hat{x}_{D} in the candidate signal table L shown in FIG. 10, after the number of the intermediate signals \hat{z}_{D} has been determined, the number of candidate signals \hat{x}_{D} would be less than the number of the intermediate signals \hat{z}_{D}.

As described above, based on the current algorithms of linear detection, interference cancellation detection or lattice reduction detection etc., the signal receiving method according to this invention improves significantly the signal detection performance of a MIMO wireless communication system, so that when at a high signal-to-noise ratio, the bit-error performance of using the signal receiving method of this invention approaches the bit-error performance of a system using the maximum likelihood detection algorithm. At the same time, the signal receiving method proposed in this invention would not lead to any significant increase in the system's computation complexity, therefore the exploitation of this invention has relatively good feasibility.

When applying the signal receiving method of this invention, the signal receiving equipment according to this invention would include: a wireless channel state information acquisition unit for acquiring a wireless channel state information matrix H; a lattice reduction conversion unit for performing lattice reduction conversion to the matrix H, so as to obtain a converted wireless channel state information matrix \tilde{H}=HT; a compensation unit for compensating a receiving signal y based on the matrix \tilde{H} to obtain a detection signal \tilde{z}; a first signal processing unit for obtaining a candidate signal table L based on the detection signal \tilde{z}, with the table L consisting of at least one candidate signal \hat{x}_{D}; a second signal processing unit for multiplying respectively the intermediate signals \hat{z}_{D} by the converting matrix T, and for obtaining a candidate signal table L by confining each product signal T\hat{z}_{D} into the signal in a modulation constellation diagram for a transmitting signal x, with the table L consisting of at least one candidate signal \hat{x}_{D}; a decision unit for obtaining a decision signal bit b based on the candidate signal table L.

In addition, in order to resist the frequency selective fading in a wireless channel, the MIMO wireless signal transmission technology can be combined with orthogonal frequency division multiplex (OFDM) multiple carrier technology. When the signal receiving method according to this invention is used in such a MIMO wireless communication system, firstly, the receiving signal y_{ƒ} on each sub-carrier of the multiple carrier system needs to be separated. Then, the receiving signal y_{ƒ} on each sub-carrier is treated as the receiving signal of a single carrier MIMO wireless communication system for corresponding treatments, namely the receiving signal on each sub-carrier is detected. By the same principle, when the signal receiving equipment according to this invention is used in a multiple input/multiple output multiple carrier wireless communication system, the equipment also includes a filter unit for separating receiving signals y_{ƒ} on the sub-carriers of the multiple carrier system. Then, to the receiving signal y_{ƒ} on each sub-carrier, the equipment includes one set of the equipment units for corresponding processing to the receiving signal y_{ƒ}, thereby to detect the receiving signal on each sub-carrier.

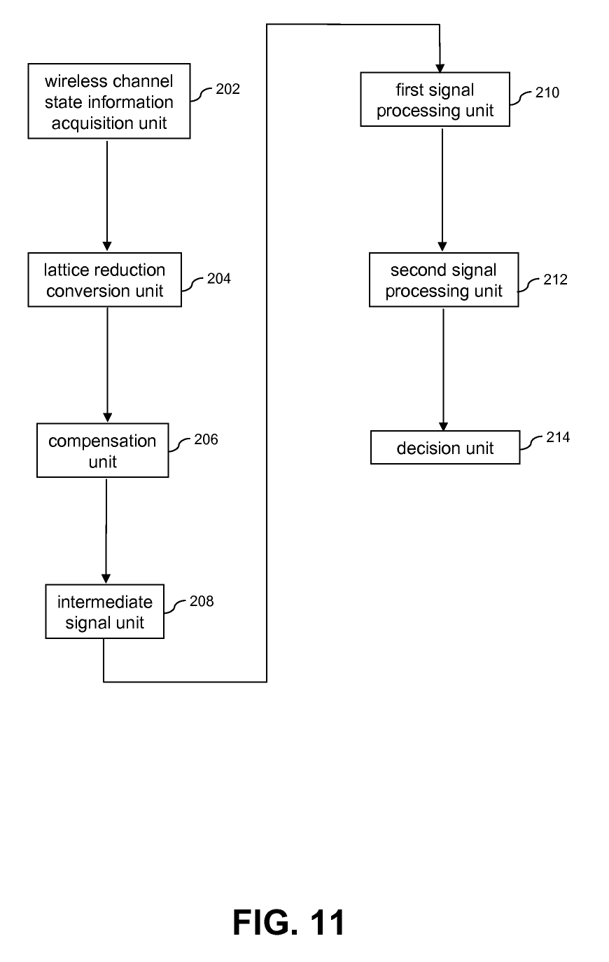

The method described above can be performed by components like those illustrated in FIG. 11. The components may be discrete units or include one or more programmed processors executing instructions stored on at least one computer readable medium. The units may include a wireless channel state information acquisition unit 202 acquiring a wireless channel state information matrix; a lattice reduction conversion unit 204 performing lattice reduction conversion to the wireless channel state information matrix to obtain a converted wireless channel state information matrix; a compensation unit 206 compensating a receiving signal based on the converted wireless channel state information matrix to obtain a detection signal; an intermediate signal unit 208 obtaining an intermediate signal table based on the detection signal, where the intermediate signal table includes at least two intermediate signals; a first signal processing unit 210 obtaining a candidate signal table based on the detection signal, where the candidate signal table includes at least one candidate signal; a second signal processing unit 212 multiplying respectively intermediate signals by the converting matrix to obtain product signals and obtaining a candidate signal table by confining each product signal as indicated by a modulation constellation diagram for a transmitting signal, where the candidate signal table includes at least one candidate signal; and a decision unit 214 obtaining a decision signal bit based on the candidate signal table.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

What is claimed is:

1. A method for receiving signals in a multiple input/multiple output wireless communication system, comprising:
obtaining a wireless channel state information matrix;
applying lattice reduction conversion to the wireless channel state information matrix to obtain a converted wireless channel state information matrix;
compensating a receiving signal based on the converted wireless channel state information matrix to obtain a detection signal;
obtaining an intermediate signal table based on the detection signal, where the intermediate signal table includes at least two intermediate signals;
multiplying respectively the intermediate signals by the converting matrix to obtain product signals;
obtaining a candidate signal table by confining each product signal as indicated by a modulation constellation diagram for a transmitting signal, where the candidate signal table includes at least one candidate signal; and
obtaining a decision signal bit based on the candidate signal table.

2. A method for receiving signals as claimed in claim 1, wherein said compensating of the receiving signal utilizes a linear detection algorithm.

3. A method for receiving signals as claimed in claim 1, wherein said compensating of the receiving signal utilizes a serial interference cancellation detection algorithm.

4. A method for receiving signals as claimed in claim 1, wherein said obtaining the intermediate signal table comprises:
quantizing respectively each element in the detection signal into a closest integer;
selecting from the detection signal at least one most unreliable element;
quantizing the selected element once again into a next closest integer; and
combining integers obtained by said quantizing of the elements to obtain the intermediate signal table.

5. A method for receiving signals as claimed in claim 4, wherein the most unreliable element has a difference with a closest integer that has a largest absolute value of all elements in the detection signal.

6. A method for receiving signals as claimed in claim 1, wherein said obtaining the decision signal bit comprises:
multiplying respectively candidate signals in the candidate signal table with the wireless channel state information matrix to obtain candidate product signals;
selecting from the candidate signals a smallest candidate signal which produces a smallest Euclidean distance between a corresponding candidate product signal and the receiving signal; and
demodulating the smallest candidate signal to obtain the decision signal bit.

7. A method for receiving signals as claimed in claim 1, wherein said obtaining of the decision signal bit utilizes a detecting and decoding iteration method based on the candidate signal table.

8. A method for receiving signals as claimed in claim 7, wherein said obtaining the decision signal bit comprises:
obtaining, based on the candidate signal table and first prior information of a transmitting signal bit, second prior information of the transmitting signal bit;
performing channel decoding to the second prior information to obtain the first prior information; and
obtaining the decision signal bit based on the second prior information.

9. A method for receiving signals as claimed in claim 7, wherein said obtaining the decision signal bit comprises:
obtaining first extrinsic information of a transmitting signal bit based on the candidate signal table and first prior information of the transmitting signal bit;
de-interleaving the first extrinsic information to obtain second prior information of the transmitting signal bit;
performing channel decoding to the second prior information to obtain second extrinsic information of the transmitting signal bit;
interleaving the second extrinsic information to obtain the first prior information; and
obtaining the decision signal bit based on the second prior information.

10. A method for receiving signals as claimed in claim 1, wherein the multiple input/multiple output wireless communication system is a multiple input/multiple output multiple carrier wireless communication system.

11. A method for receiving signals as claimed in claim 10, further comprising, before said obtaining of the wireless channel state information matrix, separating receiving signals on sub-carriers of the multiple input/multiple output multiple carrier wireless communication system.

12. Signal receiving equipment in a multiple input/multiple output wireless communication system, comprising:
a wireless channel state information acquisition unit acquiring a wireless channel state information matrix;
a lattice reduction conversion unit performing lattice reduction conversion to the wireless channel state information matrix to obtain a converted wireless channel state information matrix;
a compensation unit compensating a receiving signal based on the converted wireless channel state information matrix to obtain a detection signal;
a first signal processing unit obtaining a candidate signal table based on the detection signal, where the candidate signal table includes at least one candidate signal;
a second signal processing unit multiplying respectively intermediate signals by the converting matrix to obtain product signals and obtaining a candidate signal table by confining each product signal as indicated by a modulation constellation diagram for a transmitting signal, where the candidate signal table includes at least one candidate signal; and
a decision unit obtaining a decision signal bit based on the candidate signal table.

13. Signal receiving equipment as claimed in claim 12, wherein said compensation unit uses a linear detection algorithm to compensate the receiving signal.

14. Signal receiving equipment as claimed in claim 12, wherein said compensation unit uses a serial interference cancellation detection algorithm to compensate the receiving signal.

15. Signal receiving equipment as claimed in claim 12, wherein said first signal processing unit first quantizes respectively each element in the detection signal into a closest integer, then selects from the detection signal at least one most unreliable element, and quantizes the at least one most unreliable element once again into a next closest integer and finally combines integers obtained by quantizing the elements to obtain the intermediate signal table.

16. Signal receiving equipment as claimed in claim 15, wherein the most unreliable element has a difference with a closest integer that has a largest absolute value of all elements in the detection signal.

17. Signal receiving equipment as claimed in claim 12, wherein the decision unit first multiplies respectively the candidate signals in the candidate signal table with the wireless channel state information matrix, then selects from the candidate signals a smallest candidate signal which produces a smallest Euclidean distance between a corresponding candidate product signal and the receiving signal and finally the decision unit demodulates the smallest candidate signal to obtain the decision signal bit.

18. Signal receiving equipment as claimed in claim 12, wherein the decision unit uses a detecting and decoding iteration method to obtain the decision signal bit based on the candidate signal table.

19. Signal receiving equipment as claimed in claim 18, wherein the decision unit first obtains first extrinsic information of a transmitting signal bit based on the candidate signal table and first prior information of the transmitting signal bit and de-interleaves the first extrinsic information to obtain second prior information of the transmitting signal bit; then performs channel decoding to the second prior information to obtain second extrinsic information of the transmitting signal bit and interleaves the second extrinsic information to obtain the first prior information, and finally obtains the decision signal bit based on the second prior information.

20. Signal receiving equipment as claimed in claim 12, wherein the multiple input/multiple output wireless communication system is a multiple input/multiple output multiple carrier wireless communication system.

21. Signal receiving equipment as claimed in claim 20, further comprising a filter unit separating receiving signals on sub-carriers of the multiple input/multiple output multiple carrier wireless communication system.

22. Signal receiving equipment as claimed in claim 12, further comprising an intermediate signal unit obtaining an intermediate signal table based on the detection signal, where the intermediate signal table includes at least two intermediate signals.
